(19) United States
(12) Patent Application Publication
(10) Pub. No.: US 2023/0151643 A1
(43) Pub. Date: May 18, 2023

(54) MESH TYPE GATE AND REEL LOCKING DEVICE THEREFOR

(71) Applicant: Yangfei Huang, Guangzhou (CN)

(72) Inventor: Yangfei Huang, Guangzhou (CN)

(21) Appl. No.: 17/406,868

(22) Filed: Aug. 19, 2021

(51) Int. Cl. E05B 65/00; E06B 9/08

(52) U.S. Cl. CPC E05B 65/0014; E06B 9/08; E06B 2009/002

(57) ABSTRACT

A reel locking device includes: a reel seat; a vertical reel rotatably connected to the reel seat and used for retracting and releasing a gate mesh; a synchronization member fixedly connected to one end of the vertical reel; an automatic locking mechanism that prevents the synchronization member from rotating freely and that includes a resettable manual unlocking slider; and an elastic pressing mechanism that obstructs the movement of the manual unlocking slider and that includes a pressing member that does not obstruct the movement of the manual unlocking slider after being pressed, and that when not pressed or after resetting obstructs the movement of the manual unlocking slider. A mesh type gate is further disclosed including the above reel seat on one side and a buckle seat on another side, where a free end of the gate mesh includes a pull ring for being fastened to the buckle seat.

### TECHNICAL FIELD

This utility model relates to a mesh type gate and a reel locking device therefor.

### BACKGROUND

Nowadays, existing gate locking devices can be manually unlocked by only a simple unlocking action, so that some children can also make it, which is not conducive to safer control.

Thus, how to overcome the above-mentioned defects has become an important and urgent issue to be solved by those skilled in the art.

### SUMMARY

This utility model overcomes the shortcomings of the above-mentioned technology and provides a mesh type gate and a reel locking device therefor.

To achieve the above object, this utility model adopts the following technical solutions.

There is provided a reel locking device for a mesh type gate, the reel locking device includes a reel seat. The reel seat is rotatably connected with a vertical reel for retracting and unwinding a gate mesh. A synchronization member is fixedly connected to one end of the vertical reel. The reel seat is equipped with an automatic locking mechanism for preventing the synchronization member from rotating freely. The automatic locking mechanism includes a resettable manual unlocking slider. The reel seat is further installed with an elastic pressing mechanism for obstructing the movement of the manual unlocking slider. The elastic pressing mechanism includes a pressing member that does not obstruct the movement of the manual unlocking slider after being pressed, and that hinders the movement of the manual unlocking slider both when it is not pressed down and after resetting.

There is also provided a mesh type gate that includes a reel seat disposed on one side and a buckle seat disposed on the other side. The reel seat is rotatably connected with a vertical reel for retracting and unwinding a gate mesh. A synchronization member is fixedly connected to one end of the vertical reel. The reel seat is equipped with an automatic locking mechanism for preventing the synchronization member from rotating freely. The automatic locking mechanism includes a resettable manual unlocking slider. The reel seat is further installed with an elastic pressing mechanism for obstructing the movement of the manual unlocking slider. The elastic pressing mechanism includes a pressing member that does not obstruct the movement of the manual unlocking slider after being pressed, and that hinders the movement of the manual unlocking slider both when it is not pressed down and after resetting. The free end of the gate mesh is provided with a pull ring that is operative to be caught by the buckle seat.

Compared with the prior art, the present disclosure provides the following benefits.

1. The structure of the reel locking device of this application is simple and easy to implement. By providing the automatic locking mechanism, automatic locking is realized, facilitating to prevent the free rotation of the synchronization member (31) and the vertical reel (3), thus achieving safety control. By providing the manual unlocking slider (41), it facilitates the manual unlocking of the automatic locking mechanism. Furthermore, the arrangement of the pressing member (51) facilitates the hindering of the movement of the manual unlocking slider (41) both when the pressing member (51) is not pressed and after resetting. That is, when the pressing member (51) is not pressed and after resetting, it prevents the manual unlocking slider (41) from changing the working state of the automatic locking mechanism, thus realizing safety control. In order to change the working state of the automatic locking mechanism, first the pressing member (51) needs to be pressed, before you are able to manually unlock the slider (41) to reset from the unlocked position or move from the reset position to the unlocked position. In addition, when the manual unlocking slider (41) is in the reset position, the automatic locking mechanism is in the locked state, so that when the user only presses the pusher (51) and does not operate the manual unlocking slider (41), the automatic locking mechanism is still in the locked state, and so it is generally difficult for children to perform the two-step unlocking operation, resulting in real practicability.

2. In this application, the first elastic driving member (43) of the automatic locking mechanism is arranged to facilitate the driving the movable block (42) to move towards the synchronization member (31), thereby realizing the automatic locking of the automatic locking mechanism. Furthermore, the second elastic driving member (44) is arranged in order that the manual unlocking slider (41) can be automatically reset when the manual unlocking slider (41) is in the unlocked position and there is no obstruction, so that the first elastic driving member (43) drives the movable block (42) to reset, thus resetting and locking the automatic locking mechanism, resulting in good practicability.

3. In this application, by arranging the first color body (410) and the second color body (110), the color bodies of different colors would appear when the manual unlocking slider (41) is in different positions, facilitating the user to know the current working state of the automatic locking mechanism, hence good practicability.

4. In this application, the third elastic driving member (52) of the elastic pressing mechanism is provided to facilitate driving the pressing member (51) to reset upward. The first interlocking portion (411) and the second interlocking portion (511) are arranged so that the when the manual unlocking slider (41) is in the unlocked position the second interlocking portion (511) is reset upward to be interlocked or engaged with the first interlocking portion (411), allowing the manual unlocking slider (41) to be kept in the unlocked position and unable to be reset. As such, the user can spare his hand to pull and secure the gate mesh (2), providing real practicality. Further, pressing down the pressing member (51) can release the engagement between the first interlocking portion (411) and the second interlocking portion (511) so that the manual unlocking slider (41) can be reset.

5. According to this application, the structure of the mesh-type gate is simple and easy to implement. The vertical reel (3) is arranged to facilitate the retracting and unwinding of the gate mesh (2), and takes up little space after rolling up the gate mesh (2). By providing the automatic locking mechanism, automatic locking is realized, facilitating to prevent the free rotation of the synchronization member (31) and the vertical reel (3), thus achieving safety control. By providing the manual unlocking slider (41), it facilitates the manual unlocking of the automatic locking mechanism. Furthermore, the arrangement of the pressing member (51) facilitates the hindering of the movement of the manual unlocking slider (41) both when the pressing member (51) is not pressed and after resetting. That is, when the pressing member (51) is not pressed and after resetting, it prevents the manual unlocking slider (41) from changing the working state of the automatic locking mechanism, thus realizing safety control. In order to change the working state of the automatic locking mechanism, first the pressing member (51) needs to be pressed, before you are able to manually unlock the slider (41) to reset from the unlocked position or move from the reset position to the unlocked position. In addition, when the manual unlocking slider (41) is in the reset position, the automatic locking mechanism is in the locked state, so that when the user only presses the pusher (51) and does not operate the manual unlocking slider (41), the automatic locking mechanism is still in the locked state, and so it is generally difficult for children to perform the two-step unlocking operation, resulting in real practicability. The pull ring (21) is arranged at the free end of the gate mesh (2) to facilitate pulling out the gate mesh (2) and hook it onto the buckle seat (6) arranged on the other side, thus achieving the gate function.

### BRIEF DESCRIPTION OF DRAWINGS

FIG. 1 is a schematic diagram of a mesh-type gate according to the present disclosure.

FIG. 2 is a schematic diagram of the mesh-type gate shown in 1 with some parts hidden.

FIG. 3 is an exploded view of FIG. 2.

FIG. 4 is an enlarged view of part A shown in FIG. 1.

FIG. 5 is an exploded view of the partial structure shown in FIG. 4.

FIG. 6 is a first schematic diagram of the structure shown in FIG. 4 with some parts hidden.

FIG. 7 is a schematic diagram of a manually unlocking slider (41) according to the present disclosure.

FIG. 8 is a second schematic diagram of the structure shown in FIG. 4 with some parts hidden, in which the first interlocking portion (411) and the second interlocking portion (511) are interlocked together, and the manual unlocking slider (41) is pressed against the movable block (42).

FIG. 9 is a diagram showing another state of the structure shown in FIG. 4.

FIG. 10 is a diagram of the structure shown in FIG. 9 with some parts hidden, in which the first interlocking portion (411) and the second interlocking portion (511) are not interlocked, and the manual unlocking slider (41) is not pressed against the movable block (42).

### DETAILED DESCRIPTION

The features of the utility model and other related features will be further described in detail below through some particular embodiments, so as to facilitate the understanding by those skilled in the art.

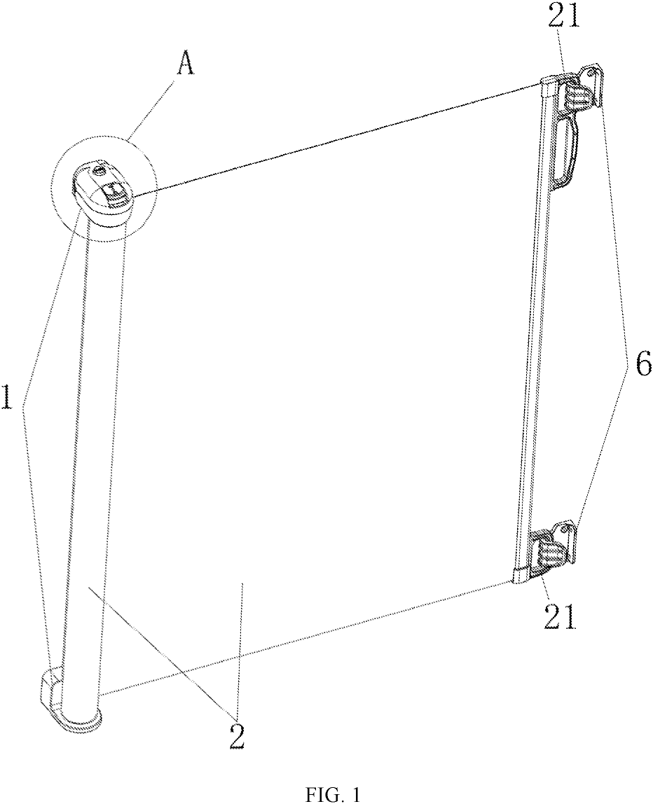

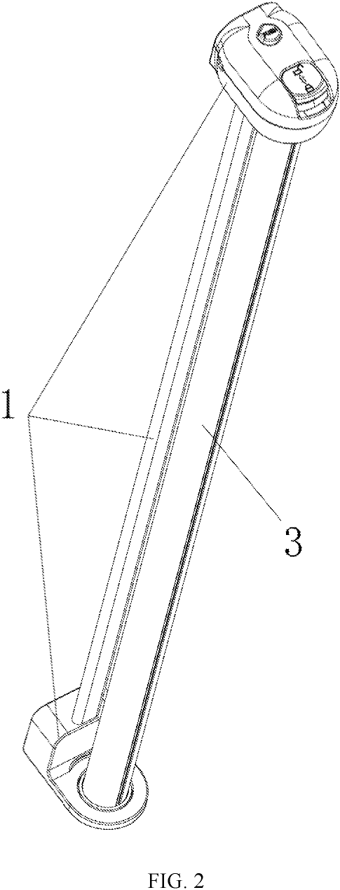

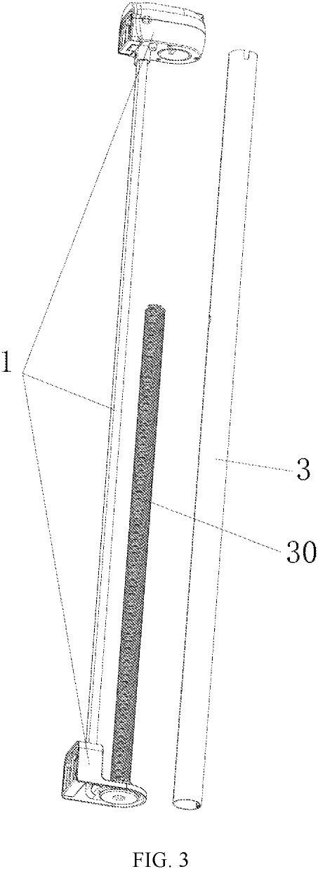

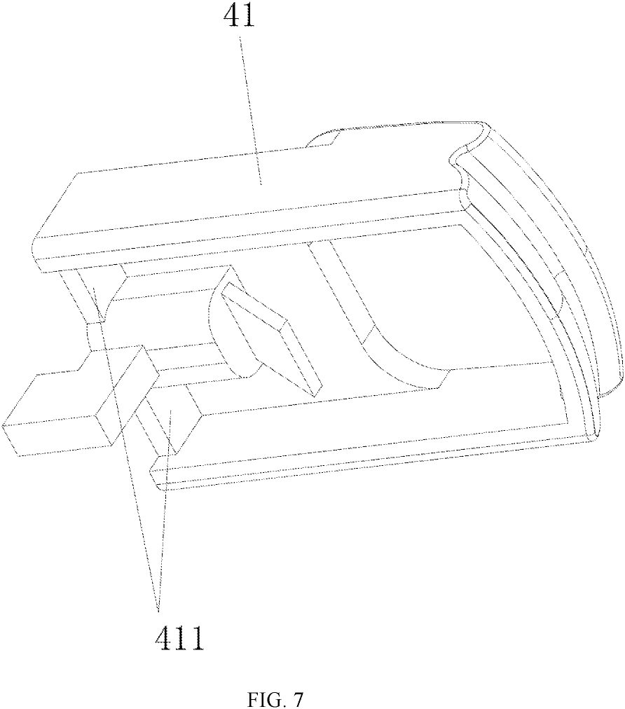

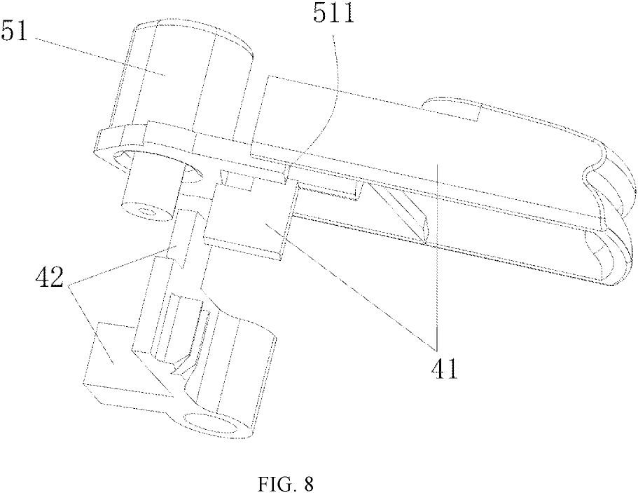

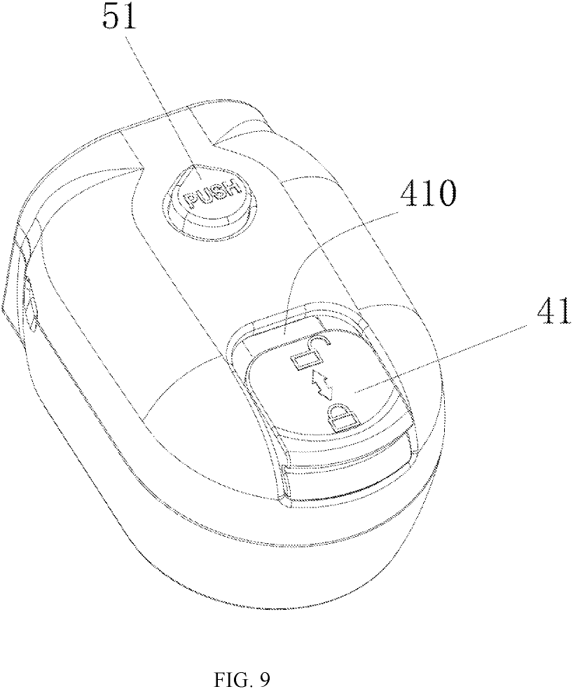

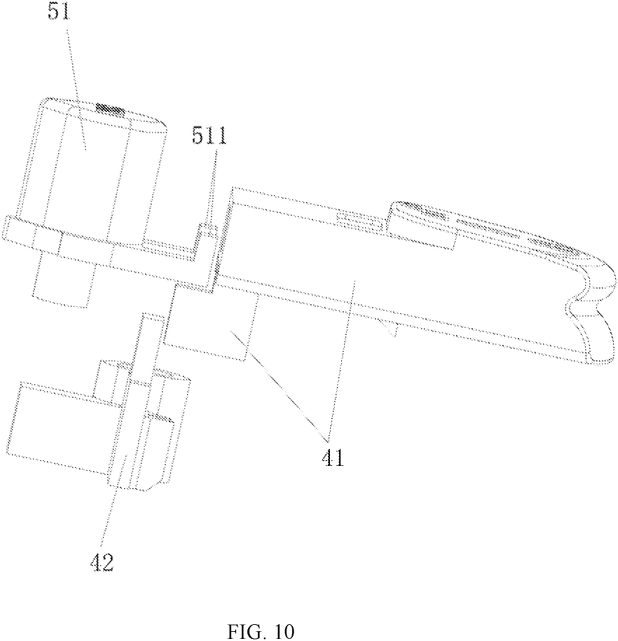

As illustrated in FIGS. 1 to 10, there is provided a reel locking device for a mesh type gate, the reel locking device includes a reel seat (1), which is rotatably connected with a vertical reel (3) for retracting and unwinding a gate mesh (2). A synchronization member (31) is fixedly connected to one end of the vertical reel (3). The reel seat (1) is equipped with an automatic locking mechanism for preventing the synchronization member (31) from rotating freely. The automatic locking mechanism includes a resettable manual unlocking slider (41). The reel seat (1) is further installed with an elastic pressing mechanism for obstructing the movement of the manual unlocking slider (41). The elastic pressing mechanism includes a pressing member (51) that does not obstruct the movement of the manual unlocking slider (41) after being pressed, and that hinders the movement of the manual unlocking slider (41) both when it is not pressed down and after resetting.

As mentioned above, the structure of the reel locking device of this application is simple and easy to implement. By providing the automatic locking mechanism, automatic locking is realized, facilitating to prevent the free rotation of the synchronization member (31) and the vertical reel (3), thus achieving safety control. By providing the manual unlocking slider (41), it facilitates the manual unlocking of the automatic locking mechanism. Furthermore, the arrangement of the pressing member (51) facilitates the hindering of the movement of the manual unlocking slider (41) both when the pressing member (51) is not pressed and after resetting. That is, when the pressing member (51) is not pressed and after resetting, it prevents the manual unlocking slider (41) from changing the working state of the automatic locking mechanism, thus realizing safety control. In order to change the working state of the automatic locking mechanism, first the pressing member (51) needs to be pressed, before you are able to manually unlock the slider (41) to reset from the unlocked position or move from the reset position to the unlocked position. In addition, when the manual unlocking slider (41) is in the reset position, the automatic locking mechanism is in the locked state, so that when the user only presses the pusher (51) and does not operate the manual unlocking slider (41), the automatic locking mechanism is still in the locked state, and so it is generally difficult for children to perform the two-step unlocking operation, resulting in real practicability.

As mentioned above, in specific implementations, the reel seat (1) in this application may be assembled from multiple parts.

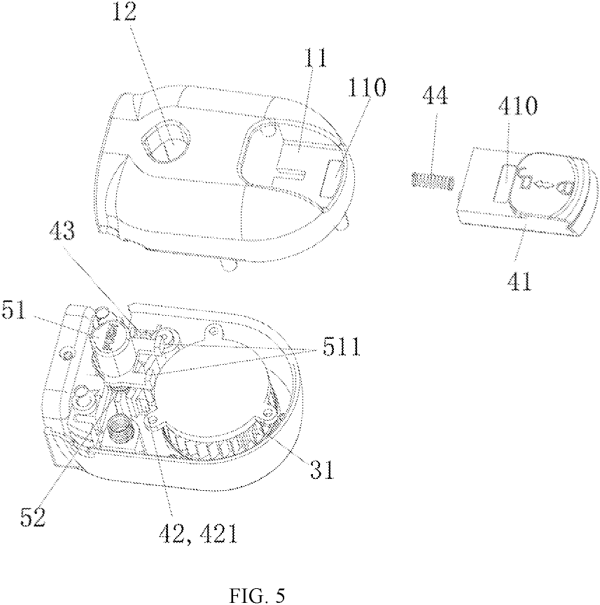

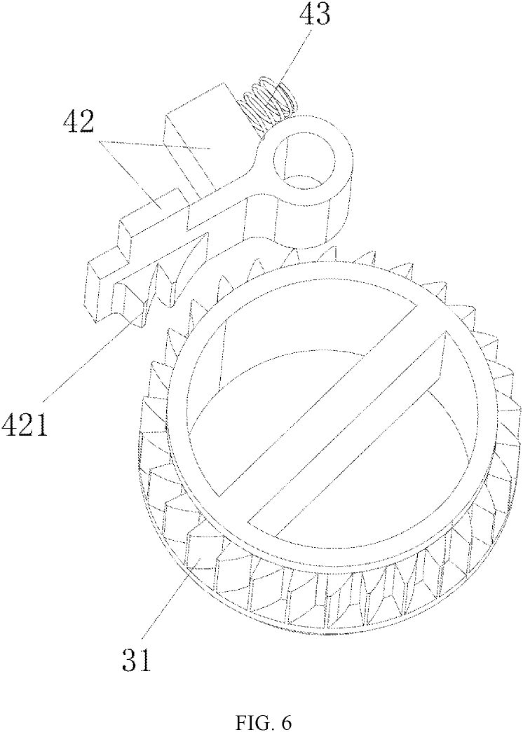

As illustrated in FIGS. 5 and 6, in specific implementations, the automatic locking mechanism may include a movable block (42) for blocking the synchronization member (31), a first elastic driving member (43) for driving the movable block (42) to move to and engage with the synchronization member (31), and a second elastic driving member (44) for driving the manual unlocking slider (41) to reset, where pushing the manual unlocking slider (41) in the direction of the movable block (42) can press the movable block (42) away from the synchronization member (31).

As mentioned above, in this application, the first elastic driving member (43) of the automatic locking mechanism is arranged to facilitate the driving the movable block (42) to move towards the synchronization member (31), thereby realizing the automatic locking of the automatic locking mechanism. Furthermore, the second elastic driving member (44) is arranged in order that the manual unlocking slider (41) can be automatically reset when the manual unlocking slider (41) is in the unlocked position and there is no obstruction, so that the first elastic driving member (43) drives the movable block (42) to reset, thus resetting and locking the automatic locking mechanism, resulting in good practicability.

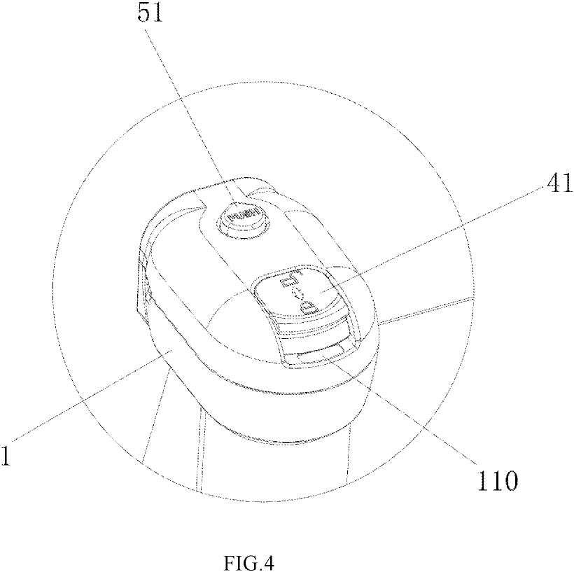

As illustrated in FIGS. 4, 5, and 9, in specific implementations, the reel seat (1) is provided with a transverse groove (11) in which the manual unlocking slider (41) and the second elastic driving member (44) are arranged and a vertical through hole (12) for the upper end of the pressing member (51) to appear outward. The manual unlocking slider (41) is provided with a first color body (410), and the transverse groove (11) is provided with a second color body (110), where the first color body (410) and the second color body (110) have different colors. When the manual unlocking slider (41) is in the reset position, the first color body (410) appears outward and the second color body (110) is covered by the manual unlocking slider (41). Otherwise when the manual unlocking slider (41) is in the unlocking position, the first color body (410) is covered by the transverse groove (11) and the second color body (110) appears outward.

As mentioned above, in this application, by arranging the first color body (410) and the second color body (110), the color bodies of different colors would appear when the manual unlocking slider (41) is in different positions, facilitating the user to know the current working state of the automatic locking mechanism, hence good practicability.

As mentioned above, in specific implementations, the synchronization member (31) may be a gear, and the movable block (42) is rotatably mounted on the reel seat (1), and its free end is provided with a clamping tooth portion (421) for being engaged with the tooth groove of the gear, which is convenient to implement.

As mentioned above, in specific implementations, it may also include a winding spring (30) for driving the vertical reel (3) to automatically roll up the gate mesh (2). As illustrated in FIG. 6, the teeth of the synchronization member (31) and/or the teeth of the clamping tooth portion (421) are such oriented that when the movable block (42) is elastically blocking the synchronization member (31), it does not hinder the winding spring (30) from driving the vertical reel (3) and the synchronization member (31) to rotate in the forward direction, but prevents the synchronization member (31) from rotating in the reverse direction. In this way, in actual use it facilitates hindering the further drawing of the gate mesh (2) while not hindering the vertical reel (3) from automatically rolling and tightening the gate mesh (2) when the automatic locking mechanism is locked, which prevents the other end of the gate mesh (2) from loosening.

As illustrated in FIGS. 4, 5, 8, and 10, in specific implementations, the elastic pressing mechanism includes a third elastic driving member (52) for driving the pressing member (51) to reset upward. The manual unlocking slider (41) is provided with a first interlocking portion (411), and the pressing member (51) is provided with a second interlocking portion (511) that is able to be interlocked with the first interlocking portion (411) when the pressing member (51) is reset upwards so that the manually unlocked slider (41) can be kept in the unlocked position and cannot be reset. Pressing down the pressing member (51) can release the interlocking of the first interlocking portion (411) and the second interlocking portion (511) so that the manual unlocking slider (41) can be reset. When the manual unlocking slider (41) and the pressing member (51) are each in the reset position, the pressing member (51) or the second interlocking portion (511) on it hinders the manual unlocking slider (41) from moving to the unlocked position.

As mentioned above, in this application, the third elastic driving member (52) of the elastic pressing mechanism is provided to facilitate driving the pressing member (51) to reset upward. The first interlocking portion (411) and the second interlocking portion (511) are arranged so that the when the manual unlocking slider (41) is in the unlocked position the second interlocking portion (511) is reset upward to be interlocked or engaged with the first interlocking portion (411), allowing the manual unlocking slider (41) to be kept in the unlocked position and unable to be reset. As such, the user can spare his hand to pull and secure the gate mesh (2), providing real practicality. Further, pressing down the pressing member (51) can release the engagement between the first interlocking portion (411) and the second interlocking portion (511) so that the manual unlocking slider (41) can be reset.

As illustrated in FIGS. 1 to 10, this application further discloses a mesh-type gate, which includes a reel seat (1) on one side and a buckle seat (6) on the other side. The real seat (1) is rotatably connected with a vertical reel (3) for retracting and unwinding a gate mesh (2). A synchronization member (31) is fixedly connected to one end of the vertical reel (3). The reel seat (1) is equipped with an automatic locking mechanism for preventing the synchronization member (31) from rotating freely. The automatic locking mechanism includes a resettable manual unlocking slider (41). The reel seat (1) is further installed with an elastic pressing mechanism for obstructing the movement of the manual unlocking slider (41). The elastic pressing mechanism includes a pressing member (51) that does not obstruct the movement of the manual unlocking slider (41) after being pressed, and that hinders the movement of the manual unlocking slider (41) both when it is not pressed down and after resetting. The free end of the gate mesh (2) is provided with a pull ring (21) for being fastened to the buckle seat (6).

As mentioned above, according to this application, the structure of the mesh-type gate is simple and easy to implement. The vertical reel (3) is arranged to facilitate the retracting and unwinding of the gate mesh (2), and takes up little space after rolling up the gate mesh (2). By providing the automatic locking mechanism, automatic locking is realized, facilitating to prevent the free rotation of the synchronization member (31) and the vertical reel (3), thus achieving safety control. By providing the manual unlocking slider (41), it facilitates the manual unlocking of the automatic locking mechanism. Furthermore, the arrangement of the pressing member (51) facilitates the hindering of the movement of the manual unlocking slider (41) both when the pressing member (51) is not pressed and after resetting. That is, when the pressing member (51) is not pressed and after resetting, it prevents the manual unlocking slider (41) from changing the working state of the automatic locking mechanism, thus realizing safety control. In order to change the working state of the automatic locking mechanism, first the pressing member (51) needs to be pressed, before you are able to manually unlock the slider (41) to reset from the unlocked position or move from the reset position to the unlocked position. In addition, when the manual unlocking slider (41) is in the reset position, the automatic locking mechanism is in the locked state, so that when the user only presses the pusher (51) and does not operate the manual unlocking slider (41), the automatic locking mechanism is still in the locked state, and so it is generally difficult for children to perform the two-step unlocking operation, resulting in real practicability. The pull ring (21) is arranged at the free end of the gate mesh (2) to facilitate pulling out the gate mesh (2) and hook it onto the buckle seat (6) arranged on the other side, thus achieving the gate function.

As illustrated in FIGS. 5 and 6, in specific implementations, the automatic locking mechanism may include a movable block (42) for blocking the synchronization member (31), a first elastic driving member (43) for driving the movable block (42) to move to and engage with the synchronization member (31), and a second elastic driving member (44) for driving the manual unlocking slider (41) to reset, where pushing the manual unlocking slider (41) in the direction of the movable block (42) can press the movable block (42) away from the synchronization member (31).

As mentioned above, in this application, the first elastic driving member (43) of the automatic locking mechanism is arranged to facilitate the driving the movable block (42) to move towards the synchronization member (31), thereby realizing the automatic locking of the automatic locking mechanism. Furthermore, the second elastic driving member (44) is arranged in order that the manual unlocking slider (41) can be automatically reset when the manual unlocking slider (41) is in the unlocked position and there is no obstruction, so that the first elastic driving member (43) drives the movable block (42) to reset, thus resetting and locking the automatic locking mechanism, resulting in good practicability.

As mentioned above, in specific implementations, the synchronization member (31) is a gear, the movable block (42) is rotatably mounted on the reel seat (1) and its free end is provided with a clamping tooth portion (421) for being engaged with the tooth groove of the gear, which is convenient to implement. The mesh-type gate may also include a winding spring (30) for driving the vertical reel (3) to automatically roll up the gate mesh (2). As illustrated in FIG. 6, the teeth of the synchronization member (31) and/or the teeth of the clamping tooth portion (421) are such oriented that when the movable block (42) is elastically blocking the synchronization member (31), it does not hinder the winding spring (30) from driving the vertical reel (3) and the synchronization member (31) to rotate in the forward direction, but prevents the synchronization member (31) from rotating in the reverse direction. In this way, in actual use it facilitates hindering the further drawing of the gate mesh (2) while not hindering the vertical reel (3) from automatically rolling and tightening the gate mesh (2) when the automatic locking mechanism is locked, which prevents the other end of the gate mesh (2) from loosening.

As illustrated in FIGS. 4, 5, 8, and 10, in specific implementations, the elastic pressing mechanism includes a third elastic driving member (52) for driving the pressing member (51) to reset upward. The manual unlocking slider (41) is provided with a first interlocking portion (411), and the pressing member (51) is provided with a second interlocking portion (511) that is able to be interlocked with the first interlocking portion (411) when the pressing member (51) is reset upwards so that the manually unlocked slider (41) can be kept in the unlocked position and cannot be reset. Pressing down the pressing member (51) can release the interlocking of the first interlocking portion (411) and the second interlocking portion (511) so that the manual unlocking slider (41) can be reset. When the manual unlocking slider (41) and the pressing member (51) are each in the reset position, the pressing member (51) or the second interlocking portion (511) on it hinders the manual unlocking slider (41) from moving to the unlocked position.

As mentioned above, in this application, the third elastic driving member (52) of the elastic pressing mechanism is provided to facilitate driving the pressing member (51) to reset upward. The first interlocking portion (411) and the second interlocking portion (511) are arranged so that the when the manual unlocking slider (41) is in the unlocked position the second interlocking portion (511) is reset upward to be interlocked or engaged with the first interlocking portion (411), allowing the manual unlocking slider (41) to be kept in the unlocked position and unable to be reset. As such, the user can spare his hand to pull and secure the gate mesh (2), providing real practicality. Further, pressing down the pressing member (51) can release the engagement between the first interlocking portion (411) and the second interlocking portion (511) so that the manual unlocking slider (41) can be reset.

As is described in the foregoing, this application protects a mesh gate and a reel locking device therefor. All technical solutions that are the same as or similar to this application should fall within the scope of protection of this application.

What is claimed is:

1. A reel locking device for a mesh-type gate, comprising:
a reel seat;
a vertical reel, rotatably connected to the reel seat and used for retracting and unwinding a gate mesh;
a synchronization member, fixedly connected to one end of the vertical reel;
an automatic locking mechanism, used for preventing the synchronization member from rotating freely, the automatic locking mechanism comprising a resettable manual unlocking slider; and
an elastic pressing mechanism, installed on the reel seat (1) and used for obstructing the movement of the manual unlocking slider, the elastic pressing mechanism comprising a pressing member that after being pressed is operative to not obstruct the movement of the manual unlocking slider, and that when not pressed or after resetting is operative to obstruct the movement of the manual unlocking slider.

2. The reel locking device of claim 1, wherein the automatic locking mechanism comprises:
a movable block, used for engaging with the synchronization member;
a first elastic driving member, used for driving the movable block to move towards and engage the synchronization member; and
a second elastic driving member, used for driving the manual unlocking slider to reset, wherein pushing the manual unlocking slider in the direction of the movable block is operative to press the movable block away from the synchronization member.

3. The reel locking device of claim 1, wherein the reel seat comprises a transverse groove in which the manual unlocking slider and the second elastic driving member are arranged, and a vertical through hole for an upper end of the pressing member to appear outward, wherein the manual unlocking slider comprises a first color body, and the transverse groove comprises a second color body, the first color body and the second color body having different colors;
wherein when the manual unlocking slider is in a reset position, the first color body is operative to appear outward and the second color body is covered by the manual unlocking slider; otherwise when the manual unlocking slider is in an unlocking position, the first color body is covered by the transverse groove and the second color body is operative to appear outward.

4. The reel locking device of claim 2, wherein the synchronization member is a gear, and the movable block is rotatably mounted on the reel seat, and wherein a free end of the movable block comprises a clamping tooth portion used for engaging with a tooth groove of the gear.

5. The reel locking device of claim 4, further comprising a winding spring used for driving the vertical reel to automatically roll up and release the gate mesh, wherein teeth of the synchronization member and teeth of the clamping tooth portion are such oriented that when the movable block is elastically engaging the synchronization member, the movable block does not hinder the winding spring from driving the vertical reel and the synchronization member to rotate in a forward direction, but prevents the synchronization member from rotating in a reverse direction.

6. The reel locking device of claim 1, wherein the elastic pressing mechanism comprises a third elastic driving member used for driving the pressing member to reset upward, wherein the manual unlocking slider comprises a first interlocking portion, and the pressing member comprises a second interlocking portion that is operative to be interlocked with the first interlocking portion when the pressing member is reset upwards so that the manually unlocked slider is operative to be kept in the unlocked position and cannot be reset, wherein pressing down the pressing member allows for the release of the interlocking of the first interlocking portion and the second interlocking portion so that the manual unlocking slider is operative to be reset;
wherein when the manual unlocking slider and the pressing member are each in the reset position, the pressing member or the second interlocking portion is operative to hinder the manual unlocking slider from moving to the unlocked position.

7. A mesh-type gate, comprising a reel seat disposed on one side and a buckle seat disposed on another side, wherein the real seat is rotatably connected with a vertical reel used for retracting and unwinding a gate mesh, wherein one end of the vertical reel is fixedly connected with a synchronization member; the reel seat is equipped with an automatic locking mechanism used for preventing the synchronization member from rotating freely; the automatic locking mechanism comprises a resettable manual unlocking slider; the reel seat is further installed with an elastic pressing mechanism used for obstructing the movement of the manual unlocking slider; the elastic pressing mechanism comprises a pressing member that after being pressed does not obstruct the movement of the manual unlocking slider, and that when being pressed and after resetting is operative to hinder the movement of the manual unlocking slider, wherein a free end of the gate mesh comprises a pull ring used for being fastened to the buckle seat.

8. The mesh-type gate of claim 7, wherein the automatic locking mechanism comprises:
a movable block, used for engaging the synchronization member;
a first elastic driving member, used for driving the movable block to move towards and engage with the synchronization member; and
a second elastic driving member, used for driving the manual unlocking slider to reset, wherein pushing the manual unlocking slider in the direction of the movable block is operative to press the movable block away from the synchronization member.

9. The mesh-type gate of claim 8, wherein the synchronization member is a gear, and the movable block is rotatably mounted on the reel seat, and wherein a free end of the movable block comprises a clamping tooth portion used for engaging with a tooth groove of the gear.

10. The mesh-type gate of claim 9, further comprising a winding spring used for driving the vertical reel to automatically roll up and release the gate mesh, wherein teeth of the synchronization member and teeth of the clamping tooth portion are such oriented that when the movable block is elastically engaging the synchronization member, the movable block does not hinder the winding spring from driving the vertical reel and the synchronization member to rotate in a forward direction, but prevents the synchronization member from rotating in a reverse direction.

11. The mesh-type gate of claim 7, wherein the elastic pressing mechanism comprises a third elastic driving member used for driving the pressing member to reset upward, wherein the manual unlocking slider comprises a first interlocking portion, and the pressing member comprises a second interlocking portion that is operative to be interlocked with the first interlocking portion when the pressing member is reset upwards so that the manually unlocked slider is operative to be kept in the unlocked position and cannot be reset, wherein pressing down the pressing member allows for the release of the interlocking of the first interlocking portion and the second interlocking portion so that the manual unlocking slider is operative to be reset;
wherein when the manual unlocking slider and the pressing member are each in the reset position, the pressing member or the second interlocking portion on it is operative to hinder the manual unlocking slider from moving to the unlocked position.

12. The mesh-type gate of claim 8, wherein the elastic pressing mechanism comprises a third elastic driving member used for driving the pressing member to reset upward, wherein the manual unlocking slider comprises a first interlocking portion, and the pressing member comprises a second interlocking portion that is operative to be interlocked with the first interlocking portion when the pressing member is reset upwards so that the manually unlocked slider is operative to be kept in the unlocked position and cannot be reset, wherein pressing down the pressing member allows for the release of the interlocking of the first interlocking portion and the second interlocking portion so that the manual unlocking slider is operative to be reset;
wherein when the manual unlocking slider and the pressing member are each in the reset position, the pressing member or the second interlocking portion on it is operative to hinder the manual unlocking slider from moving to the unlocked position.

13. The mesh-type gate of claim 9, wherein the elastic pressing mechanism comprises a third elastic driving member used for driving the pressing member to reset upward, wherein the manual unlocking slider comprises a first interlocking portion, and the pressing member comprises a second interlocking portion that is operative to be interlocked with the first interlocking portion when the pressing member is reset upwards so that the manually unlocked slider is operative to be kept in the unlocked position and cannot be reset, wherein pressing down the pressing member allows for the release of the interlocking of the first interlocking portion and the second interlocking portion so that the manual unlocking slider is operative to be reset;
wherein when the manual unlocking slider and the pressing member are each in the reset position, the pressing member or the second interlocking portion on it is operative to hinder the manual unlocking slider from moving to the unlocked position.

14. The mesh-type gate of claim 10, wherein the elastic pressing mechanism comprises a third elastic driving member used for driving the pressing member to reset upward, wherein the manual unlocking slider comprises a first interlocking portion, and the pressing member comprises a second interlocking portion that is operative to be interlocked with the first interlocking portion when the pressing member is reset upwards so that the manually unlocked slider is operative to be kept in the unlocked position and cannot be reset, wherein pressing down the pressing member allows for the release of the interlocking of the first interlocking portion and the second interlocking portion so that the manual unlocking slider is operative to be reset;
wherein when the manual unlocking slider and the pressing member are each in the reset position, the pressing member or the second interlocking portion on it is operative to hinder the manual unlocking slider from moving to the unlocked position.
